(19) United States
(12) Patent Application Publication
(10) Pub. No.: US 2010/0306703 A1
(43) Pub. Date: Dec. 2, 2010

(54) METHOD, DEVICE, MODULE, APPARATUS, AND COMPUTER PROGRAM FOR AN INPUT INTERFACE

(75) Inventors: Remy Bourganel, London (GB); Edwin Shannon, London (GB); Mattias Andersson, London (GB); Roni Burrell, London (GB); Joseph MacLeod, London (GB); Tom Jenkins, London (GB); Antti Tenhunen, Palokka (FI)

Correspondence Address: Perman & Green, LLP, 99 Hawley Lane, Stratford, CT, 06614, US

(73) Assignee: NOKIA CORPORATION, Espoo (FI)

(21) Appl. No.: 12/597,354

(22) PCT Filed: Jun. 25, 2007
(86) PCT No.: PCT/IB07/01903

§ 371 Date: Aug. 13, 2010

Related U.S. Application Data
(60) Provisional application No. 60/914,096, filed on Apr. 26, 2007.

(51) Int. Cl. G06F 3/048

(52) U.S. Cl. 715/823; 715/834

(57) ABSTRACT

A method for accessing services in an apparatus that includes a multidetector is disclosed. A corresponding device, module and apparatus are also disclosed. Further, a computer program product for implementing the method is disclosed.

### FIELD OF THE INVENTION

The present invention relates to a method, a device, a module and an apparatus comprising such a device, as well as a computer program product comprising instructions for carrying out said method.

### BACKGROUND OF THE INVENTION

Mobile devices such as mobile telephones, personal digital assistants, portable media players etc. generally have user interfaces containing user input keys. The main purpose of the keypad is character input, but the keypad is also used for menu navigation, control and selection of items on the screen. Many mobile devices also have alternative or supplementary input means, such as scroll wheels, jog dials, track balls, disc dials, etc. These types of input means are often used for navigation and selection.

Although these types of input interfaces are user friendly, switching between different input means for controlling different functions and operations is often required. As the mobile devices of today become more and more complex, there is an increasing need for multifunctional input means and methods that still remain simple and intuitive for the user.

### SUMMARY

In view of the above, an objective of the invention is to solve or at least reduce the problems discussed above. In particular, an objective is to provide a user friendly input interface of an apparatus where different services and applications are presented in form of items in a circular menu system and accessed through one and the same input means. The same input means may be used for making items in a circular menu system rotate on a display as well as performing navigation and selection of options.

The present invention is based on the understanding that a rotating movement, a navigation input, and a selection input may be detected through the same input means.

A particular advantage of the present invention is that a so called multidetector is providing a user friendly input means through which different types of interactions are performed thus reducing the number of key presses and avoiding switching between input means.

According to a first aspect of the present invention, there is provided a method for accessing services in an apparatus comprising a display and a multidetector, the method comprising:

displaying a plurality of primary items in a circular menu system;

detecting a rotating movement of the multidetector;

rotating, in response to the rotating movement, the plurality of primary items in the circular menu system, highlighting one primary item at a time;

displaying for a currently highlighted primary item a plurality of selectable secondary items associated with the highlighted primary item; and

detecting a navigation input of the multidetector;

highlighting in response to the navigation input a selectable secondary item of the plurality of secondary items.

The method may comprise:

detecting a selection input of the multidetector; and

executing in response to the selection input a corresponding processor action.

The method may comprise:

displaying for a currently highlighted secondary item a plurality of selectable further items associated with the highlighted secondary item;

detecting a further navigation input of the multidetector;

highlighting in response to the further navigation input a selectable further item of the plurality of selectable further items;

detecting a selection input of the multidetector; and

executing in response to the selection input a corresponding processor action.

The selectable further item may be a graphical item.

The method may further comprise:

presenting a list of podcasts;

detecting a user input associated with previewing a selected podcast of the list of podcasts;

presenting a preview of the selected podcast; and

presenting the user with an option to subscribe to the selected podcast.

The rotating movement of the multidetector may activate the displaying of the plurality of primary items in the circular menu system.

The displaying of the plurality of primary items in the circular menu system may be activated by pressing a special key.

The plurality of primary items may further comprise an initially highlighted default primary item.

The initially highlighted default primary item may be definable by the user.

The initially highlighted default primary item may be the last selected primary item.

The initially highlighted default primary item may be the in the current context most relevant primary item.

The plurality of secondary items may have dynamic data, the dynamic data being data stored and updated outside the apparatus.

According to a second aspect of the present invention there is provided a multidetector comprising an interaction area being arranged to detect:

a rotating movement;

a navigation input; and

a selection input.

According to a third aspect of the present invention there is provided a module comprising a multidetector comprising an interaction area being arranged to detect:

a rotating movement;

a navigation input; and

a selection input.

According to a fourth aspect of the present invention there is provided an apparatus comprising a processor, a display, and a multidetector comprising an interaction area being arranged to detect:

a rotating movement;

a navigation input; and

a selection input.

The apparatus may comprise a processor, a display, and a multidetector,

the processor may be configured to display a plurality of primary items in a circular menu system;

the processor may be configured to detect a rotating movement of the multidetector;

the processor may be configured to rotate, in response to the rotating movement, the plurality of primary items in the circular menu system, highlighting one primary item at a time;

the processor may be configured to display for a currently highlighted primary item a plurality of selectable secondary items associated with the highlighted primary item;

the processor may be configured to detect a navigation input of the multidetector; and

the processor may be configured to highlight in response to the navigation input a selectable secondary item of the plurality of secondary items.

The processor may further be configured to:

detect a selection input of the multidetector; and

execute in response to the selection input a corresponding processor action.

The processor may further be configured to:

display for a currently highlighted secondary item a plurality of selectable further items associated with the highlighted secondary item;

detect a further navigation input of the multidetector;

highlight in response to the further navigation input a selectable further item of the plurality of selectable further items;

detect a selection input of the multidetector; and

execute in response to the selection input a corresponding processor action.

The processor may further be configured to:

present a list of podcasts;

detect a user input associated with previewing a selected podcast of the list of podcasts;

present a preview of the selected podcast; and

present the user with an option to subscribe to the selected podcast.

The apparatus may comprise a mobile telephone, a personal digital assistant, a portable media player, a digital camera, a remote control device, a cordless telephone, a game console, or a videophone, or any combination thereof.

The multidetector may be any combination of a group comprising a scroll wheel, a pressable scroll wheel, a multidirectional joystick, a jog dial, a jog wheel, a track ball, disc dial, and a touch sensitive screen.

The multidetector, module, and apparatus according the second to fourth aspects of the present invention are suitable for implementing the method according to the first aspect of the present invention, and may thus be arranged accordingly.

According to a fifth aspect of the present invention there is provided a computer program product comprising instructions for:

displaying a plurality of primary items in a circular menu system;

detecting a rotating movement of the multidetector;

rotating, in response to the rotating movement, the plurality of primary items in the circular menu system, highlighting one primary item at a time;

displaying for a currently highlighted primary item a plurality of selectable secondary items associated with the highlighted primary item;

detecting a navigation input of the multidetector;

highlighting in response to the navigation input a selectable secondary item of the plurality of secondary items.

The computer program product may comprise instructions for:

detecting a selection input of the multidetector;

executing in response to the selection input a corresponding processor action.

The computer program product may comprise instructions for:

displaying for a currently highlighted secondary item a plurality of selectable further items associated with the highlighted secondary item;

detecting a further navigation input of the multidetector;

highlighting in response to the further navigation input a selectable further item of the plurality of selectable further items;

detecting a selection input of the multidetector;

executing in response to the selection input a corresponding processor action/function.

The computer program product may further comprise instructions for: presenting a list of podcasts;

detecting a user input associated with previewing a selected podcast of the list of podcasts;

presenting a preview of the selected podcast; and

presenting the user with an option to subscribe to the selected podcast.

In this context, i.e. for the first to fifth aspect of the present invention, a multidetector may be a user input device on a user input interface of an apparatus. The multidetector may be a scroll wheel, a pressable scroll wheel, a multidirectional joystick, a jog dial, a jog wheel, a track ball, disc dial, or a touch sensitive screen. A multidetector may be construed as a multidetector means. Thus the term multidetector is equivalent to the term multidetector means, which may be equivalent to any of the group comprising a scroll wheel, a pressable scroll wheel, a multidirectional joystick, a jog dial, a jog wheel, a track ball, disc dial, and a touch sensitive screen.

In this context a rotating movement may be actuated by a user performing a rotation of an input means, such as touching the rim area of a multidetector in a circular clockwise or anti-clockwise movement. The rotating movement may also be actuated by turning the input means or by performing a circular movement on a touch sensitive screen.

A primary item may represent a particular service available on an apparatus, such as for example “Music”, “Contacts”, “Photos”, “Games”, etc.

A secondary item may represent a particular option from a list of options associated with a primary item. If for example a primary item is “Music”, a secondary item can be a playlist.

In the same way, a further item may represent a particular option from a list of options associated with a secondary item. In the example of the primary item being “Music” and the secondary item being a playlist, a further item can for example be a song from said playlist.

A navigation input may be actuated by a user pressing the navigation area of the multidetector.

A selection input may be actuated by the user pressing the selection area of the multidetector.

Dynamic data may be data stored and updated outside the apparatus. Such dynamic data may be the content of secondary items relating to, for example, a web image storing service. This dynamic data may be remotely stored and collected from a server.

Other objectives, features and advantages of the present invention will appear from the following detailed disclosure, from the attached dependent claims as well as from the drawings.

### BRIEF DESCRIPTION OF THE DRAWINGS

The above, as well as additional objects, features and advantages of the present invention, will best be understood through the following illustrative and non-limiting detailed description of preferred embodiments of the present invention, with reference to the appended drawings, where the same reference numerals will be used for similar elements, wherein:

FIG. 1 illustrates a mobile communication apparatus comprising a multidetector;

FIG. 2 illustrates a module comprising a multidetector;

FIG. 3a-3c illustrates different multidetectors;

FIG. 4 is a schematic illustration of a method according to an embodiment of the invention;

FIG. 5 is a schematic illustration of a method according to an embodiment of the invention;

FIG. 6 is a schematic illustration of a method according to an embodiment of the invention;

FIG. 7a-d are schematic illustrations of a display view of an embodiment of the present invention;

FIG. 8 is a schematic illustration of a display view of an embodiment of the present invention;

FIG. 9 is a schematic illustration of a display view of an embodiment of the present invention;

FIG. 10 is a schematic illustration of a display view of an embodiment of the present invention;

FIG. 11a-c are schematic illustrations of display views of different circular menu systems;

FIG. 12 is a schematic illustration of a hierarchical menu system of an embodiment of the present invention;

FIG. 13 is a schematic illustration of a hierarchical menu system of an embodiment of the present invention; and

FIG. 14 illustrates a mobile communication apparatus, comprising a multidetector, to which apparatus is attached a device, comprising at least one multidetector.

### DETAILED DESCRIPTION OF THE INVENTION

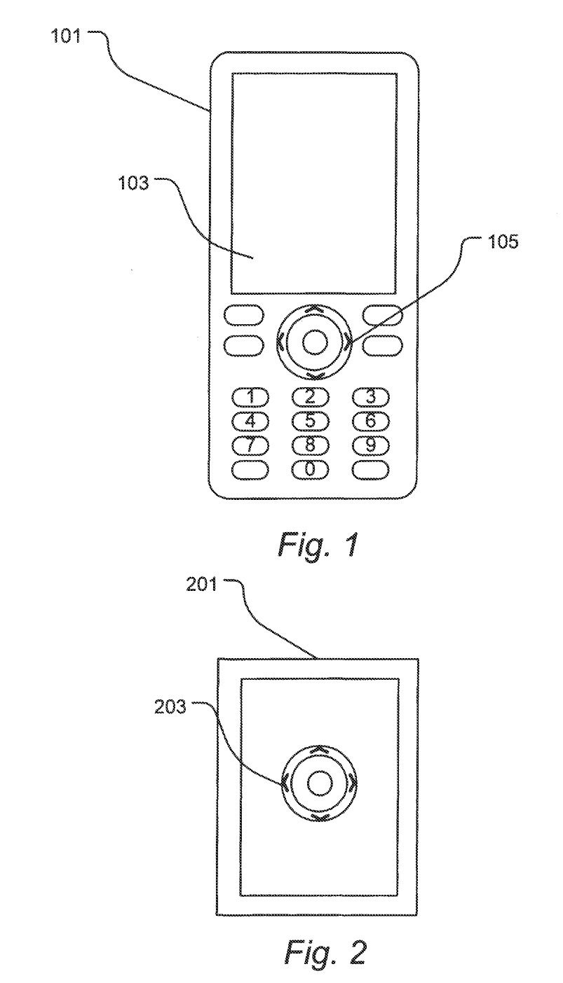

FIG. 1 is a schematic view of a mobile communication terminal 101 according to an embodiment of the present invention comprising a processor (not shown) and a user interface comprising a display 103 and an input interface. The input interface can further comprise a keypad and a multidetector 105. The mobile communication apparatus can also comprise other elements (not shown) normally present in such an apparatus, such as a speaker, a microphone, a memory, etc.

The mobile communication apparatus 101 can for example comprise a mobile telephone, a personal digital assistant, a portable media player, a digital camera, a remote control device, a cordless phone, a game console, a videophone, or any combination thereof.

The mobile communication apparatus can have a completely different appearance, where a multidetector can be placed for example on the side of the apparatus. The mobile communication apparatus can further comprise at least one other multidetector.

FIG. 2 is a schematic view of a module 201 according to an embodiment of the present invention comprising a multidetector 203 comprising an interaction area being arranged to detect a rotating movement, a navigation input and a selection input. The module 201 can according to an embodiment of the present invention be contained in a mobile communication apparatus. Other possibilities can be to apply the module as a separate user interface on another mobile device, for example on a portable media player or as a remote control for such a device. The module 201 can further comprise at least one other multidetector. The multidetector described above is equivalent to a multidetector means and can be a scroll wheel, a pressable scroll wheel, a multidirectional joystick, a jog dial, a jog wheel, a track ball, a disc dial, or a touch sensitive screen.

The multidetector can be arranged to detect a rotating movement, a navigation input, and a selection input.

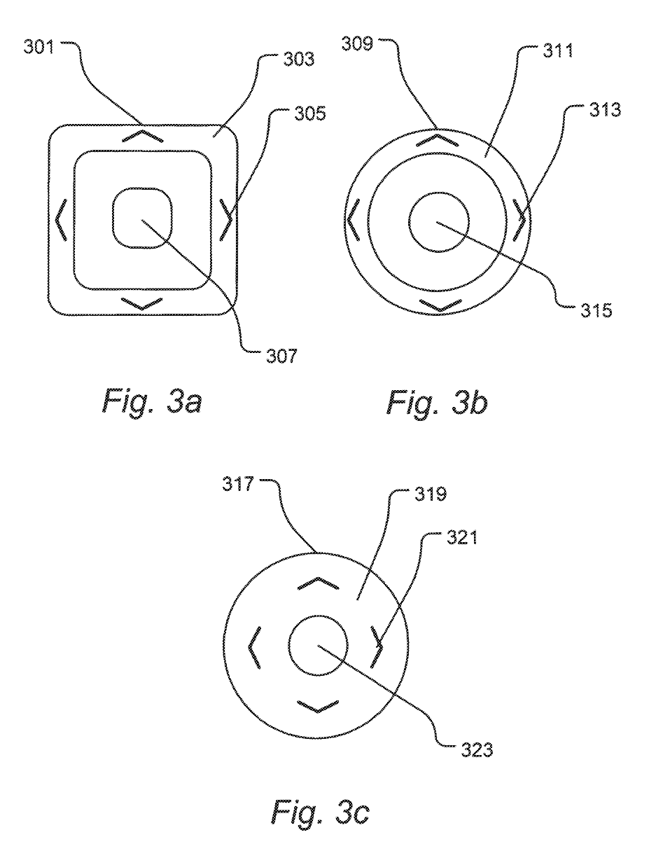

FIG. 3a illustrates a multidetector 301 comprising an interaction area comprising a rotation area 303 arranged to detect a rotating movement. The rotation area 303 can also comprise a plurality of navigation areas 305 arranged to detect a navigation input actuated by a user pressing the navigation area 305. The user pressing an area located close to the navigation area 305 can also detect the same navigation input. The multidetector 301 can further comprise a selection area 307 arranged to detect a selection input actuated by a user pressing the selection area 307.

FIG. 3b illustrates a multidetector 309 comprising an interaction area comprising a rotation area 311 arranged to detect a rotating movement. The rotation area 311 can also comprise a plurality of navigation areas 313 arranged to detect a navigation input actuated by a user pressing the navigation area 313. The user pressing an area located close to the navigation area 313 can also detect the same navigation input. The multidetector 309 can further comprise a selection area 315 arranged to detect a selection input actuated by a user pressing the selection area 315.

FIG. 3c illustrates a multidetector 317 comprising an interaction area comprising a rotation area 319 arranged to detect a rotating movement. The rotation area 319 can also comprise a plurality of navigation areas 321 arranged to detect a navigation input actuated by a user pressing the navigation area 321. The user pressing an area located close to the navigation area 321 can also detect the same navigation input. The multidetector 317 can further comprise a selection area 323 arranged to detect a selection input actuated by a user pressing the selection area 323.

The embodiments described above, with reference to FIG. 3a-c, are mainly examples of possible ways of implementing multidetectors.

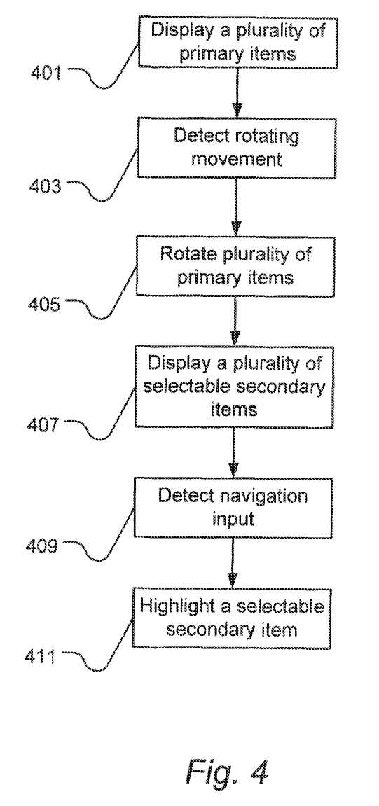

FIG. 4 illustrates a method for accessing services according to an embodiment of the present invention.

In an initial display a plurality of primary items step 401, the apparatus displays a plurality of primary items in a circular menu system. The circular menu system can be two-dimensional where the primary items are displayed sequentially on a circle in the two-dimensional plane, with one selectable primary item at a time being highlighted. The circular menu system can also be three-dimensional where the primary items are displayed sequentially on a circle in the three-dimensional plane, each primary item partially overlapping another primary item, with one selectable primary item at a time being highlighted in the foreground.

In a detect a rotating movement step 403, the apparatus detects a rotating movement via the multidetector. The user can create a rotating movement of the multidetector by touching the rim area of the multidetector and performing a circular rotating movement. The rotating movement can be done both clockwise and anti-clockwise. Depending on the appearance of the multidetector the movement can also be done in other ways.

In a rotate plurality of primary items step 405, the apparatus dynamically displays the rotating movement by rotating the plurality of primary items in the circular menu system, highlighting one primary item at a time.

In a display a plurality of selectable secondary items step 407, the apparatus displays, for a currently highlighted primary item, a plurality of selectable secondary items associated with the highlighted primary item. The plurality of secondary items can be displayed as a list of options.

In a detect a navigation input step 409, the apparatus can detect a navigation input via the multidetector. The user can make a navigation input by pressing the navigation areas on the rim area for navigation up, down, left or right.

In a highlight a selectable secondary item step 411, the apparatus can from the plurality of secondary items highlight the selectable secondary item to which the user at the time has navigated to.

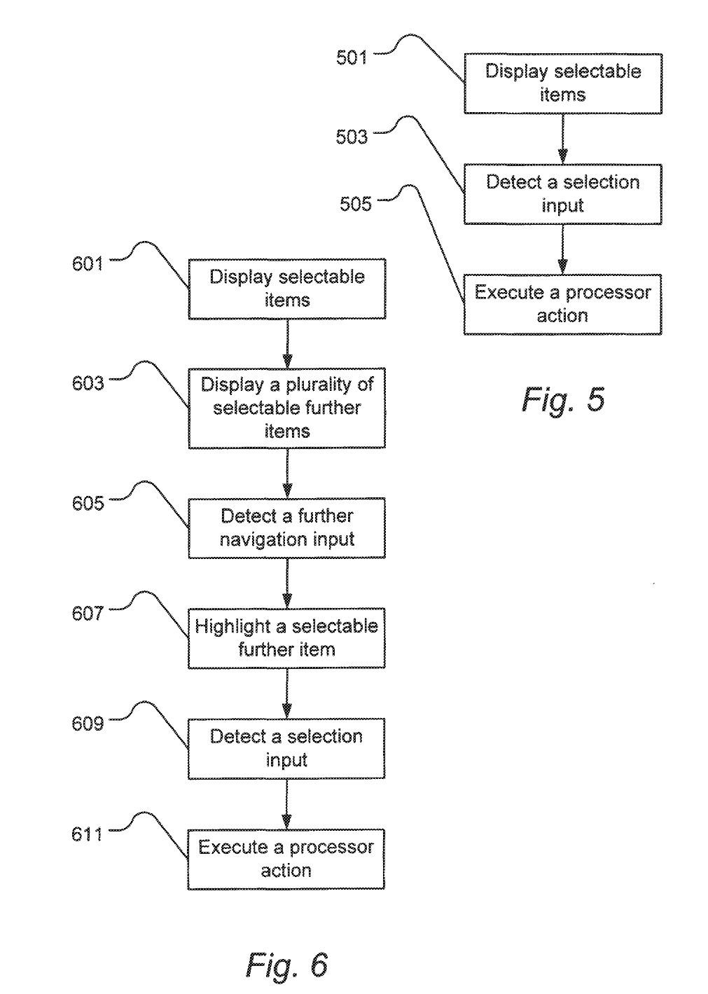

FIG. 5 illustrates a method for accessing services according to an embodiment of the present invention.

In an initial display selectable items step 501, the apparatus performs the steps detailed in FIG. 4.

In a detect a selection input step 503, the apparatus detects a selection input via the multidetector. The user can make a selection by pressing the selection area of the multidetector.

In an execute a processor action step 505, the processor of the apparatus executes instructions corresponding to the selection.

FIG. 6 illustrates a method for accessing services according to an embodiment of the present invention.

In an initial display selectable items step 601, the apparatus performs the steps detailed in FIG. 4.

In a display a plurality of selectable further items step 603, the apparatus displays a plurality of selectable further items associated with the highlighted secondary item. These further items can be functions or possible options for the currently highlighted secondary item. The further items can be displayed as a list of options or as a list of icons.

In a detect a further navigation input step 605, the apparatus can detect a further navigation input via the multidetector. The user can make a further navigation input by pressing the navigation areas on the rim area for navigation up, down, left or right.

In a highlight a selectable further item step 607, the apparatus can from the plurality of selectable further items highlight the selectable further item to which the user at the time has navigated to.

In a detect a selection input step 609, the apparatus can detect a selection input via the multidetector. The user can make a selection by pressing the selection area of the multidetector.

In an execute a processor action step 611, the processor of the apparatus executes instructions corresponding to the selection.

It is to be noted that the methods described in FIG. 4-6 can be invoked by the user performing a rotating movement of the multidetector or by pressing a special key.

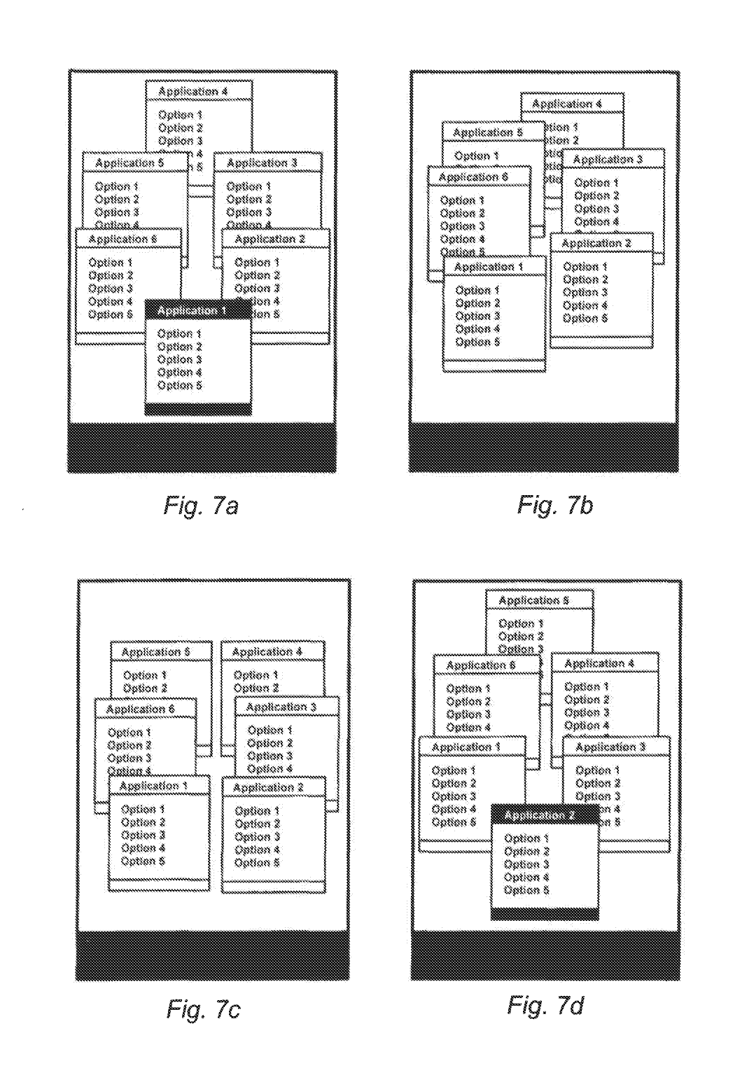

FIG. 7a-7d illustrates a sequence of display views shown during a rotating movement of a multidetector. FIG. 7a shows an initial display view with six primary items representing Applications 1 through 6, where Application 1 is a highlighted primary item. FIGS. 7b and 7c show two consecutive display views during an ongoing rotating movement. FIG. 7d shows a display view with the same six primary items representing Application 1 through 6, now with Application 2 being a highlighted primary item.

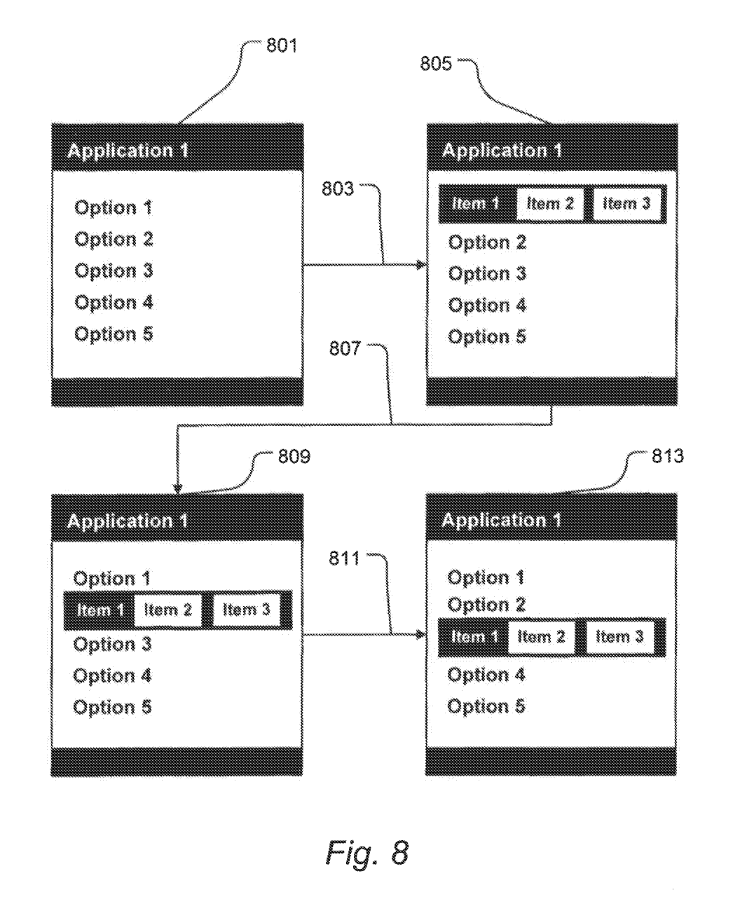

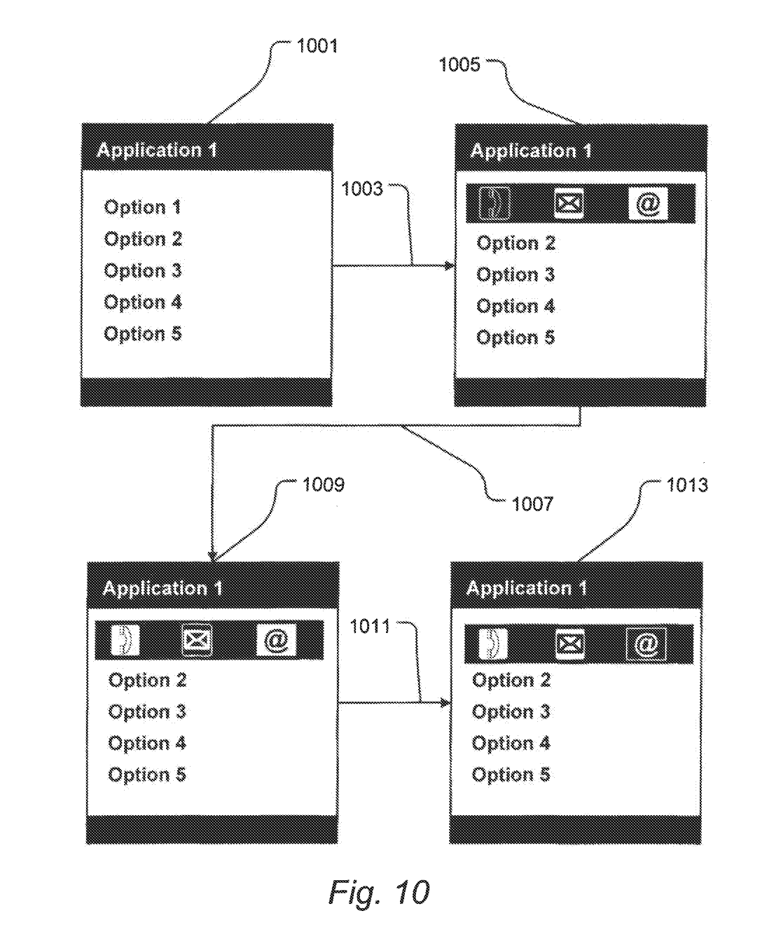

FIG. 8 illustrates an example of a user interface scenario according to an embodiment of the present invention. The example shows a first detail display view 801 for Application 1. It is to be noted that the remainder of the primary items for the services named Applications 2-6 are continued to be displayed in the background as shown in FIG. 7a. The first detail display view 801 shows a list of secondary items, Option 1 through 6, associated with Application 1. By pressing the navigation area for downwards navigation on the multidetector, the user navigates down to Option 1. As a result of this navigation input 803 the user is presented with a second detail display view 805. The second detail display view 805 displays a list of selectable further items associated with Option 1. The further items are displayed in a list, where the first item is highlighted. The user can then continue pressing the navigation area for downwards navigation on the multidetector. As a result of this navigation input 807 the user is presented with a third detail display view 809. The third detail display view 809 displays a list of selectable further items associated with Option 2. The further items are displayed in a list, where the first item is highlighted. Similarly, the user can if desired continue pressing the navigation area for downwards navigation on the multidetector. As a result of this navigation input 811 the user is presented with a fourth detail display view 813. The fourth detail display view 813 displays a list of selectable further items associated with Option 3. The further items are displayed in a list, where the first item is highlighted. The user might at any time during this scenario decide to navigate through the list of selectable further items before making a selection, which will be described in details in FIG. 10.

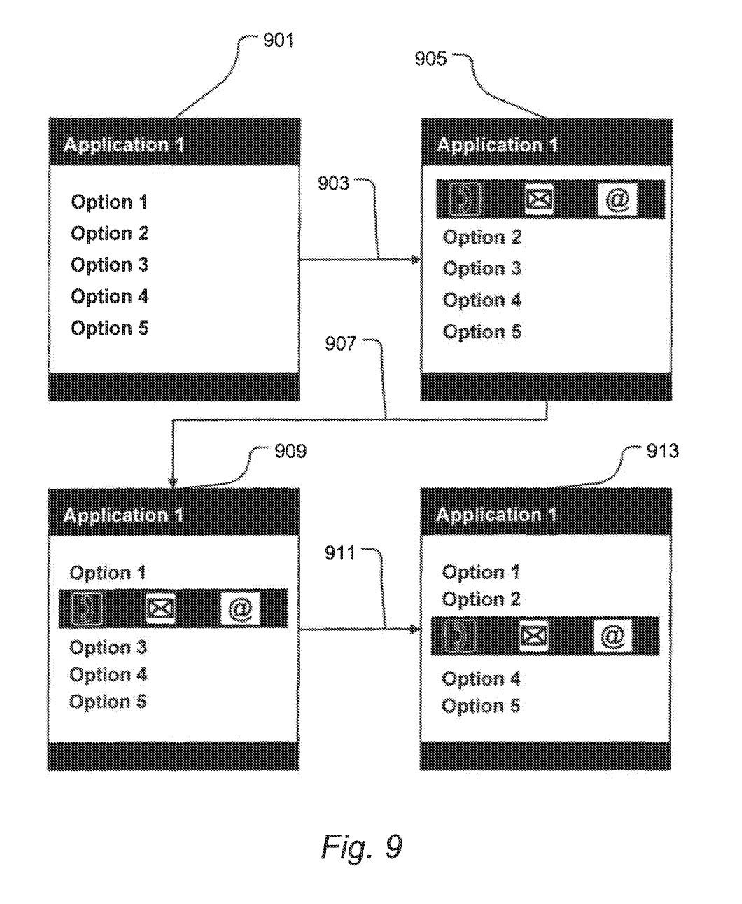

FIG. 9 illustrates an example of a user interface scenario according to an embodiment of the present invention. Similarly to FIG. 8, the example shows a first detail display view of a primary item for a service named Application 1. The first detail display view 901 shows a list of secondary items, Option 1 through 6, associated with Application 1. By pressing the navigation area for downwards navigation on the multidetector, the user navigates down to Option 1. As a result of this navigation input 903 the user is presented with a second detail display view 905. The second detail display view 905 displays a list of selectable further items, here represented as graphical items or icons, associated with Option 1. The selectable further items are displayed as a list of icons, where the first icon is highlighted. The user can then continue pressing the navigation area for downwards navigation on the multidetector. As a result of this navigation input 907 the user is presented with a third detail display view 909. The third detail display view 909 displays a list of selectable further items associated with Option 2. The selectable further items are displayed as a list of icons, where the first icon is highlighted. Similarly, the user can if desired continue pressing the navigation area for downwards navigation on the multidetector. As a result of this navigation input 911 the user is presented with a fourth detail display view 913. The fourth detail display view 913 displays a list of selectable further items associated with Option 3. The further items are displayed as a list of icons, where the first icon is highlighted. The user might at any time during this scenario decide to navigate through the list of selectable further items associated with any particular option before making a selection, which will be described in details in FIG. 10.

FIG. 10 illustrates an example of a user interface scenario according to an embodiment of the present invention. Again the example shows a first detail display view of a primary item for a service named Application 1. The first detail display view 1001 shows a list of secondary items, Option 1 through 6, associated with Application 1. By pressing the navigation area for downwards navigation on the multidetector, the user navigates down to Option 1. As a result of this navigation input 1003 the user is presented with a second detail display view 1005. The second detail display view 1005 displays a list of selectable further items, here represented as graphical items or icons, associated with Option 1. The selectable further items are displayed as a list of icons, where the first icon is highlighted. The user can the decide to navigate through the list of selectable further items associated with Option 1, by pressing the navigation area for rightwards navigation. As a result of this navigation input 1007 the user is presented with a third detail display view 1009. The third detail display view 1009 displays the same list of selectable further icons as in previous display view 1005 but now with the second icon of the list being highlighted. The user can then decide to continue navigate through the list of selectable further items associated with Option 1, by again pressing the navigation area for rightwards navigation. As a result of this navigation input 1011 the user is presented with a third detail display view 1013. The third detail display view 1013 displays the same list of selectable further icons as in previous display view 1009 but now with the third icon of the list being highlighted. The user might at any time during this scenario decide to select a selectable further item associated with any particular option by pressing the selection area of the multidetector.

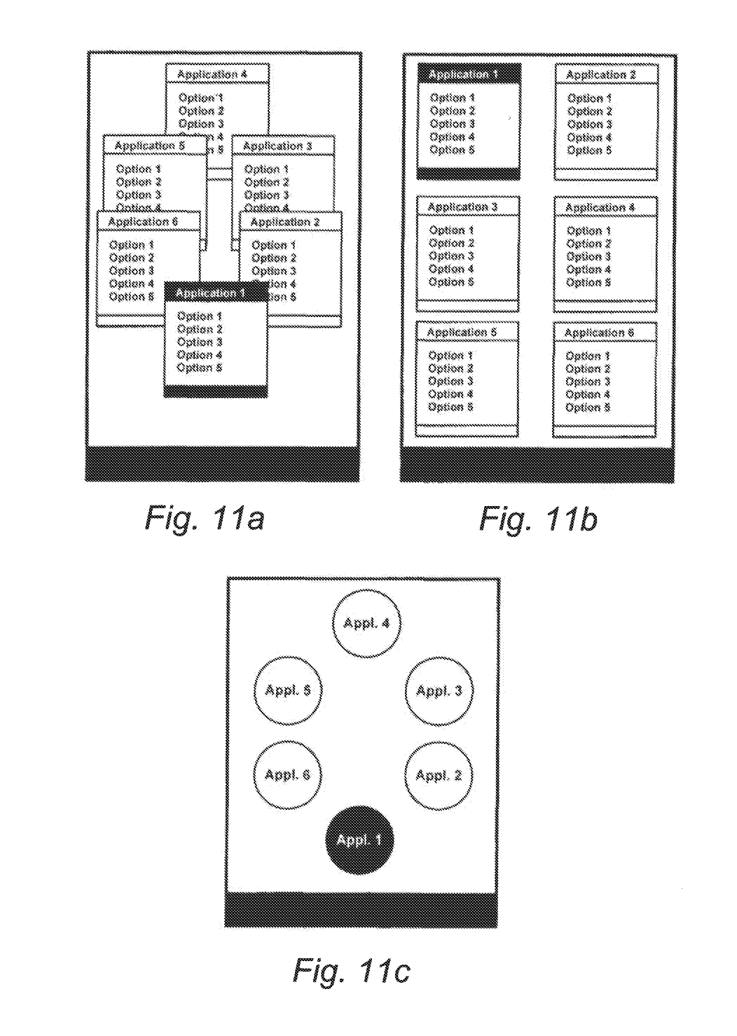

FIG. 11a illustrates an example of a circular menu system. Primary items representing Application 1 through 6 are displayed, overlapping each other, sequentially on a circle. The secondary items Options 1 through 6 associated with each primary item representing Application 1 through 6 are displayed in a vertical list.

FIG. 11b illustrates another example of a circular menu system. Primary items representing Application 1 through 6 are displayed in a two by three matrix, selectable secondary items Options 1 through 6 associated with each primary item representing Application 1 through 6 are displayed in a vertical list.

FIG. 11c illustrates yet another example of a circular menu system. Primary items representing Application 1 through 6 are displayed sequentially on a circle.

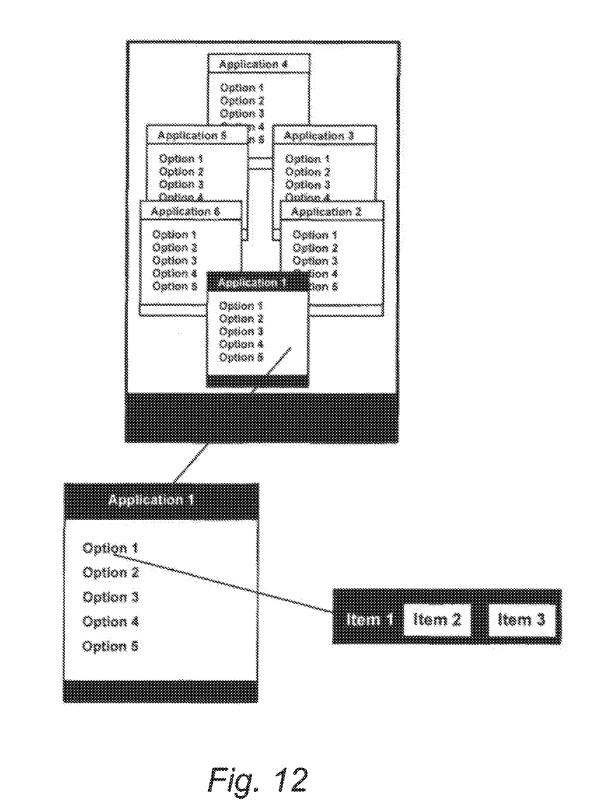

FIG. 12 illustrates an example of three different levels of a hierarchical menu system.

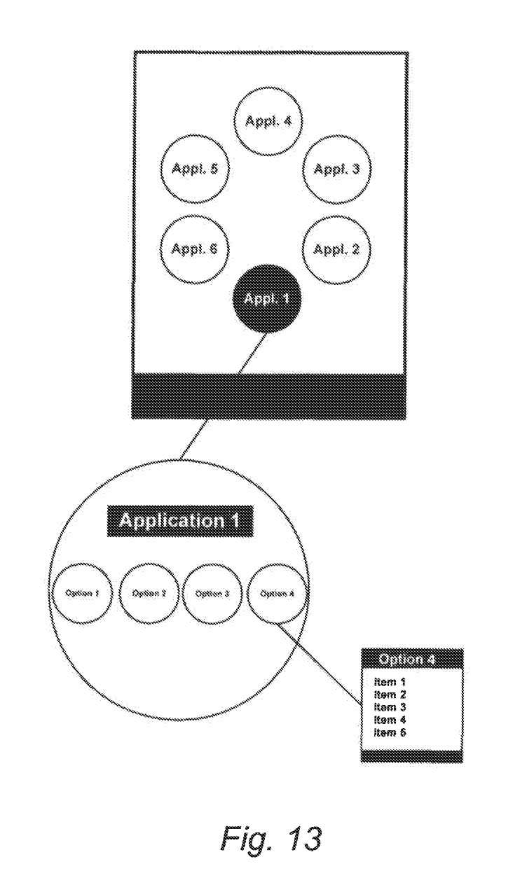

FIG. 13 illustrates another example of three different levels of a hierarchical menu system.

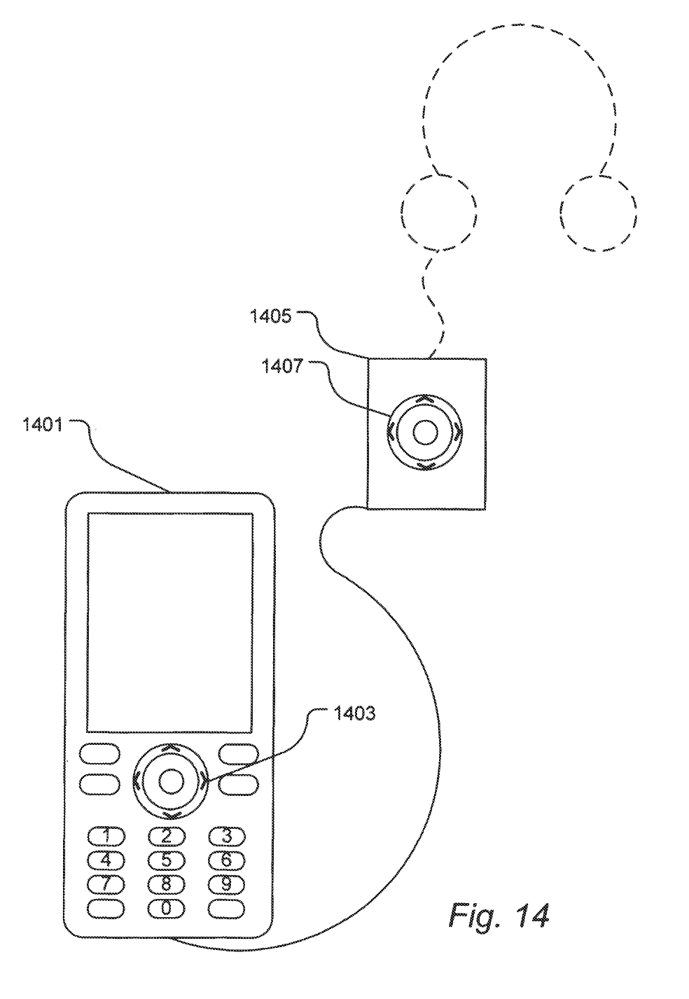

FIG. 14 illustrates a mobile communication apparatus 1401 comprising a multidetector 1403. The multidetector 1403 can be of different types and associated with different inputs such as rotation, navigation and selection, as referred to earlier. To the mobile communication apparatus is attached, via a cable or a wireless connection, a module 1405 comprising a second multidetector 1407. The module can act as a remote control adapted to control applications in the mobile communication apparatus.

In this disclosure, a multidetector should be construed as a multidetector means. Thus the term multidetector is equivalent to the term multidetector means, which can be equivalent to any of the group comprising a scroll wheel, a pressable scroll wheel, a multidirectional joystick, a jog dial, a jog wheel, a track ball, a disc dial, and a touch sensitive screen.

The invention has mainly been described above with reference to a few embodiments. However, as is readily appreciated by a person skilled in the art, other embodiments than the ones disclosed above are equally possible within the scope of the invention, as defined by the appended patent claims.

1. A method for accessing services in an apparatus comprising a display and a multidetector, said method comprising:
displaying a plurality of primary items in a circular menu system;
detecting a rotating movement of said multidetector;
rotating, in response to said rotating movement, said plurality of primary items in said circular menu system, highlighting one primary item at a time;
displaying for a currently highlighted primary item a plurality of selectable secondary items associated with said highlighted primary item;
detecting a navigation input of said multidetector; and
highlighting in response to said navigation input a selectable secondary item of said plurality of secondary items.

2. The method according to claim 1, further comprising:
detecting a selection input of said multidetector; and executing in response to said selection input a corresponding processor action.

3. The method according to claim 1, further comprising:
displaying for a currently highlighted secondary item a plurality of selectable further items associated with said highlighted secondary item;
detecting a further navigation input of said multidetector;
highlighting in response to said further navigation input a selectable further item of said plurality of selectable further items;
detecting a selection input of said multidetector; and
executing in response to said selection input a corresponding processor action.

4. The method according to claim 3, wherein said further item is a graphical item.

5. The method according to claim 1, further comprising:
presenting a list of podcasts;
detecting a user input associated with previewing a selected podcast of said list of podcasts;
presenting a preview of said selected podcast; and
presenting said user with an option to subscribe to said selected podcast.

6. The method according to claim 1, wherein said rotating movement of said multidetector activates said displaying of said plurality of primary items in said circular menu system.

7. The method according to claim 1, wherein said displaying of said plurality of primary items in said circular menu system is activated by pressing a special key of said apparatus.

8. The method according to claim 1, wherein said plurality of primary items further comprises an initially highlighted default primary item.

9. The method according to claim 8, wherein said initially highlighted default primary item is definable by the user.

10-11. (canceled)

12. The method according to claim 1, wherein said plurality of secondary items has dynamic data, said dynamic data being data stored and updated outside the apparatus.

13-15. (canceled)

16. An apparatus comprising a processor, a display, and a multidetector, said processor being configured to display a plurality of primary items in a circular menu system;
said processor being configured to detect a rotating movement of said multidetector;
said processor being configured to rotate, in response to said rotating movement, said plurality of primary items in said circular menu system, highlighting one primary item at a time;
said processor being configured to display for a currently highlighted primary item a plurality of selectable secondary items associated with said highlighted primary item;
said processor being configured to detect a navigation input of said multidetector; and
said process being configured to highlight in response to said navigation input a selectable secondary item of said plurality of secondary items.

17. The apparatus according to claim 16, wherein
said processor further being configured to detect a selection input of said multidetector; and
said processor further being configured to execute in response to said selection input a corresponding processor action.

18. The apparatus according to claim 16, wherein
said processor further being configured to display for a currently highlighted secondary item a plurality of selectable further items associated with said highlighted secondary item;
said processor further being configured to detect a further navigation input of said multidetector;
said processor further being configured to highlight in response to said further navigation input a selectable further item of said plurality of selectable further items;
said processor further being configured to detect a selection input of said multidetector; and
said processor further being configured to execute in response to said selection input a corresponding processor action.

19. The apparatus according to claim 16, wherein
said processor further being configured to present a list of podcasts;
said processor further being configured to detect a user input associated with previewing a selected podcast of said list of podcasts;
said processor further being configured to present a preview of said selected podcast; and
said processor further being configured to present said user with an option to subscribe to said selected podcast.

20. The apparatus according to claim 16, wherein said apparatus comprises a mobile telephone, a personal digital assistant, a portable media player, a digital camera, a remote control device, a cordless telephone, a game console, or a videophone, or any combination thereof.

21. The apparatus according to claim 16, wherein said multidetector is any combination of a group comprising a scroll wheel, a pressable scroll wheel, a multidirectional joystick, a jog dial, a jog wheel, a track ball, disc dial, and a touch sensitive screen.

22. A computer program product comprising instructions for;
displaying a plurality of primary items in a circular menu system;
detecting a rotating movement of said multidetector;
rotating, in response to said rotating movement, said plurality of primary items in said circular menu system, highlighting one primary item at a time;
displaying for a currently highlighted primary item a plurality of selectable secondary items associated with said highlighted primary item;
detecting a navigation input of said multidetector;
highlighting in response to said navigation input a selectable secondary item of said plurality of secondary items.

23. The computer program product according to claim 22 further comprising instructions for:
detecting a selection input of said multidetector;
executing in response to said selection input a corresponding processor action.

24. The computer program product according to claim 22 further comprising instructions for;
displaying for a currently highlighted secondary item a plurality of selectable further items associated with said highlighted secondary item;
detecting a further navigation input of said multidetector;
highlighting in response to said further navigation input a selectable further item of said plurality of selectable further items;
detecting a selection input of said multidetector;
executing in response to said selection input a corresponding processor action/function.

25. The computer program product according to claim 22 further comprising instructions for:
presenting a list of podcasts;
detecting a user input associated with previewing a selected podcast of said list of podcasts;
presenting a preview of said selected podcast; and
presenting said user with an option to subscribe to said selected podcast.
